(19) United States
(12) Patent Application Publication
(10) Pub. No.: US 2016/0241984 A1
(43) Pub. Date: Aug. 18, 2016

(54) METHOD AND APPARATUS FOR GENERATING DRIVE SIGNALS FOR LOUDSPEAKERS

(71) Applicant: KONINKLIJKE PHILIPS N.V., Eindhoven (NL)

(72) Inventor: Werner Paulus Josephus DE BRUIJN, Utrecht (NL)

(21) Appl. No.: 15/027,594

(22) PCT Filed: Oct. 15, 2014
(86) PCT No.: PCT/EP2014/072101

§ 371 Date: Apr. 6, 2016

(30) Foreign Application Priority Data
Oct. 29, 2013 (EP) 13190639.8

(51) Int. Cl. H04S 7/00

(52) U.S. Cl. CPC H04S 7/301; H04S 7/307; H04S 2400/07

(57) ABSTRACT

An audio apparatus generates drive signals for a plurality of loudspeakers (101) and comprises a receiver (103) for receiving an audio signal. A divider (105) divides typically a low frequency part of the audio signal into a plurality of audio subbands thereby providing a subband signal for each audio subband of the audio subbands. An analyzer (109) generates acoustic room response indications for each loudspeaker (101) for at least one subband. The indications may be indicative of a coupling of the individual loudspeaker to any room resonances in the individual subbands. A generator (107) generates the drive signals from the subband signals with the generator (107) being arranged to distribute at least a first subband signal of a first subband to the drive signals in response to the acoustic room response indications for the first subband. The analyzer (109) is being arranged to generate a first acoustic room response indication for a first loudspeaker (101) of the plurality of loudspeakers (101) and the first subband in response to a determination of a coupling of the first loudspeaker to at least one room resonance of an acoustic environment for the first loudspeaker (101). The apparatus may mitigate or reduce audio distortions caused by excitation of room resonances in a room.

### FIELD OF THE INVENTION

The invention relates to a method and apparatus for generating drive signals for loudspeakers, and in particular, but not exclusively, for generating low frequency drive signals.

### BACKGROUND OF THE INVENTION

Audio reproduction and rendering is continually developing towards being able to provide increasingly desirable audio experiences. This has resulted in an increasing complexity, flexibility and capability of the offered solutions. In particular, the desire to provide an enveloping and immerging experience to listeners has led to an increased focus on the provision of spatial audio. This has in particular led to rendering systems using a relatively high number of loudspeakers at positions distributed around the listening position. For example, surround sound systems using for example a 5.1 or 7.1 loudspeaker setup have become common in the consumer segment.

However, a common problem with sound reproduction, particularly in small- to mid-sized spaces such as rooms in a private home, conference rooms, studios, etc., is unbalanced bass response caused by standing waves that are related to so-called room modes. The room modes correspond to resonances or so-called Eigen-modes for the specific acoustic environments. Depending on the geometry of the room and the placement of the speakers, certain narrow frequency bands in the bass region may be excited at much greater amplitude than other frequencies. As a consequence, such narrow bands may appear to be amplified significantly (by the acoustic response of the room) leading to an unpleasant perception of so-called “boomy” bass. The opposite may also happen, i.e. the geometry and placement of the speakers may be such that certain narrow frequency bands in predominantly the bass region are effectively attenuated. Indeed, the attenuation may be to such an extent that the frequencies are essentially absent in the perceived sound, leading to a perception of overall lack of power and a lack of spectral balance. Moreover, these described problems are typically very position-dependent, and accordingly a frequency band that may be overly prominent (“boomy”) at one listening position, may be almost absent in another listening position.

This problem is in particular difficult to solve satisfactorily by means of signal processing since it is inherently caused by the physical and geometrical properties of the room. Furthermore, it is an issue which has significant practical implications as it can potentially occur with any sound reproduction system, and in particular sound reproduction systems that are capable of reproducing frequencies below, say, 150-200 Hz. As such, it includes most home audio products, such as e.g. home theatre systems with separate subwoofers, full-range stereo systems, soundbars, high-quality docking stations, etc.

Current known attempts at addressing the issue tend to be based on applying some form of (adaptive) frequency equalization based on a measured frequency response at a reference position, or on an average of frequency responses measured at multiple positions. An example of this is described in Stephen J. Elliot & Phillip A. Nelson, “Multiple-point equalization in a room using adaptive digital filters”, Journal of the Audio Engineering Society, Vol. 37(11), pp. 899-907, 1989.

The simplest implementation of such a type of system apply simple magnitude equalization. However, typically this does not remove the effect unless the problematic frequency bands are almost completely removed in the source signal. This is because the problem is caused by a strong resonance of the room, which needs only very little energy to be excited. However, a substantially complete removal of frequency bands is not a desirable solution as it distorts the sound. In particular, it tends to result in perceptible “drop-outs” in the bass portion of the rendered audio and an overall perception of a lack of power or impact of the rendered audio. More sophisticated systems also apply phase adaptation in an attempt to counteract the resonant behavior of the room-loudspeaker system. An example of this approach is described in

Aki Mäkivirta, Poju Antsalo, Matti Karjalainen, And Vesa Välimäki, “Modal equalization of loudspeaker-room responses at low frequencies”, Journal of the Audio Engineering Society, Vol. 51(5), pp. 324-343, 2003.

FR 2955442 A1 discloses an iterative procedure for determining filters that optimize the performance at one or more reference positions.

US 2004/252844 A1 discloses a method for optimizing the bass performance of a multi-loudspeaker audio system by distributing bass frequency bands over the multiple loudspeakers, where the distribution mechanism is dependent a set of transfer functions representing an influence of the modal structure of the room when propagating audio signals from the input of loudspeakers to the reference position(s) in said room. However, a fundamental short-coming of these prior art approaches is that they tend to distort the overall frequency response of the rendered audio, and/or to improve the response only at a single or a few reference positions (where the measurement was performed) while distorting the sound reproduction at other positions. Indeed, the main problem of addressing the spatial variations and spectral balance of, in particular, the bass level throughout the room is not solved by such approaches.

Another class of prior art systems is based on the principle of active absorption as e.g. described in Arturo O. Santillán, “Spatially extended sound equalization in rectangular rooms”, Journal of the Acoustical Society of America, Vol. 110(4), pp. 1989-1997, 2001. This concept is based on the notion of introducing additional loudspeakers that act as “energy sinks” for the dominant problematic frequencies. Essentially, such systems prevent standing waves from building up in the room by attenuating or offsetting the acoustical energy near a reflective wall. While this concept is reported in the literature to be effective, it is not an attractive solution for many implementations and in particular not for consumer applications. Firstly, such systems require the loudspeakers to be carefully placed in very specific locations, which is contrary to the trend in the consumer market towards freedom of placement. Secondly, it is an inefficient solution, since the generated cancellation sound waves produced by the additional speakers have the same power as the original sound waves, and thus the required power is doubled. Furthermore, in many practical implementations the requirement of having additional speakers merely to perform such compensation purposes is unacceptable.

Hence, an improved audio rendering would be advantageous, and in particular a system for providing drive signals to loudspeakers which allows increased flexibility, facilitated operation, increased flexibility of speaker setup, improved user experience, reduced user interaction, improved perceived audio quality and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an audio apparatus for generating drive signals for a plurality of loudspeakers, the audio apparatus comprising: a receiver for receiving an audio signal; a divider for dividing at least part of the audio signal into a plurality of audio subbands, the divider being arranged to provide a subband signal for each audio subband of the audio subbands; an analyzer for generating acoustic room response indications for each loudspeaker for at least a first subband; a generator for generating the drive signals from the subband signals wherein the generator is arranged to distribute at least a first subband signal of the first subband to the drive signals in response to the acoustic room response indications for the first subband.

The invention may allow improved audio reproduction in many scenarios and embodiments. In particular, it may allow an improved bass response in many embodiments and may achieve a reduced sensitivity to specific loudspeaker positions and/or characteristics of the acoustic environment. Specifically, a reduced acoustic sensitivity to and impact of room resonances in the room may be achieved.

The approach may specifically reduce the impact and sensitivity to room resonances without resulting in the introduction of notches in the spectrum of the rendered or perceived audio. Specifically, the approach may allow the rendered sound to not be attenuated at frequencies corresponding to strong room resonances. In many scenarios, the excitation of room resonances may be reduced or prevented while still allowing audio to be rendered at the corresponding frequencies.

The acoustic room response indication for a loudspeaker and subband combination may be an indication of a transfer function from the loudspeaker in the subband. The transfer function may be an average or representative for multiple listening positions, and typically of the whole room. The acoustic room response indication may be an indication of the presence, strength and/or coupling to any room resonances in the room for that subband and that loudspeaker. Specifically, the acoustic room response indication for a loudspeaker and subband combination may be an indication of the extent to which individual room resonances of the room are present and excited by the loudspeaker when rendering audio in the subband.

The generator may be arranged to distribute subband signals individually for at least some subbands in response to individual acoustic room response indications in the subbands. Thus, gains for different loudspeakers may be different for different subbands having different acoustic room response indications.

The analyzer may in many embodiments generate individual acoustic room response indications for at least some of the subbands. The subbands may together correspond to the audio signal in a given frequency range, such as often a bass frequency band (e.g. frequencies under 100-250 Hz). The individual subbands of the group of subbands for which acoustic room response indications are generated and which are distributed to the drive signals in response to the acoustic room response indications may not exceed 70 Hz, and may in many embodiments advantageously not exceed 50, 40, 30 or even 20 Hz.

The distribution of a sub-band signal may correspond to the sub-band signal being rendered by a set of the loudspeakers with a given weight. Thus, a given sub-band signal may generate a contribution (signal component) for each drive signal with a weight being dependent on the acoustic room response indications (including weights of zero and binary weights corresponding to speaker selections).

In accordance with an optional feature of the invention, the generator is arranged to select a subset of the loudspeakers for reproducing the first subband signal in response to the acoustic room response indications for the first subband.

This may provide improved performance and in many embodiments may allow improved audio reproduction. In particular, it may mitigate or in many scenarios prevent audio signals exciting room room resonances. In many scenarios, it may in particular improve the bass reproduction and reduce the perception of a “boomy” bass.

In many embodiments, the subset may consist of one speaker.

In accordance with an optional feature of the invention, the generator is arranged to not include contributions to a drive signal for a first loudspeaker if the acoustic room response indication for the first loudspeaker and the first subband does not meet a criterion.

This may provide improved performance, and in many embodiments may allow improved audio reproduction. In particular, it may mitigate or in many scenarios prevent audio signals exciting room resonances as such loudspeakers may be excluded from the set of loudspeakers that are used to render the first subband signal.

The criterion may specifically be a room resonance excitation criterion. The criterion may not be met if the first subband signal will cause an excitation of a room resonance to exceed a threshold. The room resonance may correspond to an amplification or an attenuation of the rendered audio by the room. For example, the excitation may be considered to exceed the threshold if the audio level for the first subband signal is attenuated by more than a certain amount (e.g. relative to an average level for all subbands); or if the audio level is amplified by more than a given amount. The requirement may specifically be that a coupling to the room resonances meet a given criterion.

Thus, the approach may allow improved audio rendering by not allowing subband signals to be rendered from loudspeakers where they will cause room resonances to be excited in an unacceptable way.

In accordance with an optional feature of the invention, the generator is arranged to select a fixed number of loudspeakers for each subband signal and to include the subband signal in only the selected fixed number of loudspeakers.

This may provide improved performance, and in many embodiments may allow improved audio reproduction, while maintaining low complexity.

In accordance with an optional feature of the invention, the generator is arranged to distribute the subband signals for all subbands below a frequency threshold to the drive signals in response to the acoustic room response indications.

The approach may be particularly suitable for providing improved bass audio reproduction. In particular, excitation of room resonances tend to be more critical at low frequencies. This is partly due to the amplitude change often being higher at lower frequencies, and due to the density of room resonances being substantially lower thereby resulting in each room resonance being much more noticeable.

In accordance with an optional feature of the invention, the frequency threshold is in the interval from 100 Hz to 200 Hz.

This may allow a particularly advantageous approach and may in particular allow substantially improved bass audio reproduction without distorting higher frequency ranges.

In accordance with an optional feature of the invention, wherein a bandwidth of the subbands below the frequency threshold does not exceed 60 Hz.

This may be particularly advantageous as it may often allow individual room resonances to be individually and independently compensated by the distribution of the audio signal across the loudspeakers. In many embodiments, the bandwidth may advantageously not exceed 50 Hz, 40 Hz, 30 Hz, or even 20 Hz.

In accordance with an optional feature of the invention, the generator is arranged to set a relative gain for the first subband signal for a first drive signal for a first loudspeaker of the plurality of loudspeakers in response to an acoustic room response indication for the first subband and for the first loudspeaker.

This may provide improved performance and in many embodiments may allow improved audio reproduction. The approach may allow a flexible and typically accurate adaptation to the specific acoustic environment. It may allow the rendering of the first subband signal to be dynamically adjusted to reflect the specific conditions. In particular, the degree of flexibility may typically allow improved optimization/adaptation.

In some embodiments, the gain may be set as a binary value for each loudspeaker corresponding to the speaker being either used or not used for rendering the first subband signal. However, in most embodiments, the gain for each loudspeaker may be set with much higher granularity, e.g. by selecting from more than ten different values. In some embodiments, the gain may be set as a digital value which may have as many possible values as can be expressed with the specific number of bits used to represent the digital value.

The generator may specifically be arranged to set the gain higher for the acoustic room response indication being closer to a target value than for an acoustic room response indication being further from the target value.

For example, the acoustic room response indication may be given as a scalar value indicative of a coupling to room resonances for the subband. The gain may be decreased in line with an increasing difference between the coupling and a target value for the coupling. The gain may be reduced both for the coupling being increasingly below a target value and for the coupling being increasingly above the target value.

In accordance with an optional feature of the invention, the analyzer is arranged to generate the acoustic room response indications in response to loudspeaker position data for the plurality of loudspeakers and an acoustic model of an acoustic environment for the loudspeakers.

This may provide improved and/or facilitated operation in many embodiments. In particular, it may in many embodiments avoid the need for potentially inconvenient measurements being necessary.

The acoustic model may specifically be an acoustic model of a room in which the loudspeakers are positioned.

In accordance with an optional feature of the invention, the analyzer is arranged to generate a first acoustic room response indication for a first loudspeaker of the plurality of loudspeakers and the first subband in response to a determination of a coupling of the first loudspeaker to at least one room resonance of an acoustic environment for the first loudspeaker.

This may provide improved audio rendering. In particular, the system may adapt to the specific characteristics of the room such that the distortion caused by the presence of room resonances may be reduced or even substantially avoided.

The determination of the coupling of the first loudspeaker to the at least one room resonance may be by an estimation based on measurements or may e.g. be by a theoretical evaluation, such as an evaluation of a model or a simulation.

A room resonance may be related to an acoustical Eigen-mode of the room. An Eigen-mode is a particular solution to the acoustic wave equation within the particular boundary conditions of the room. An Eigen mode corresponds to a particular Eigen-frequency (also often referred to as a resonance, natural or modal frequency) and a stationary spatial sound level distribution in the room (also referred to as a standing wave pattern) that is characteristic for that Eigen mode. The coupling to the room resonance may be an indication of the extent to which the room resonance is excited by the loudspeaker.

In accordance with an optional feature of the invention, the first acoustic room response indication is further indicative of a strength of the at least one room resonance.

This may provide improved adaptation and/or sound reproduction in many embodiments and scenarios. The strength of a room resonance may be a measure of the maximum amplitude that would occur within the room at the resonance frequency corresponding to the room resonance if a white noise signal would be played from a loudspeaker at a position of maximum coupling for the room resonance (i.e. an anti-node of the standing wave pattern corresponding to the room resonance). Depending on the Eigen-frequency and Eigen-mode type corresponding to the room resonance, some room resonances are more easily excited than others. For example, a lower-frequency room resonance may be more efficiently excited by frequencies surrounding the actual resonance frequency than a higher-frequency room resonance, so that for lower-frequency room resonances more acoustical energy from a broader range of frequencies may be “sucked into” the resonance, resulting in a higher boost of the energy in the frequency band around the resonance frequency.

In accordance with an optional feature of the invention, the analyzer is arranged to generate a first acoustic room response indication for a first loudspeaker and the first subband in response to at least one measured acoustic transfer function from the first loudspeaker to a number of microphones.

This may in many scenarios provide an accurate adaptation to the specific acoustic environment and may provide a practical and useful determination of e.g. room resonances existing in a given room. The acoustic room response indications may be determined in response to a form of averaging (or low pass filtering) over a plurality of microphones at different positions.

In accordance with an optional feature of the invention, the analyzer is arranged to generate the first acoustic room response indication in response to a measured acoustic transfer function from the first loudspeaker to a single microphone in a corner position.

This may provide accurate adaptation yet reduce the inconvenience to a user.

According to an aspect of the invention there is provided a method of generating drive signals for a plurality of loudspeakers according to claim 10.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an audio apparatus in accordance with some embodiments of the invention;

FIG. 2 illustrates an example of a frequency response of a filter bank for generating subband signals;

FIG. 3 illustrates an example of the normalized absolute sound pressure from an Eigen mode in a room;

FIG. 4 illustrates an example of the normalized absolute sound pressure from an Eigen mode in a room;

FIG. 5 illustrates an example of a combined sound pressure level from Eigen modes in a room;

FIG. 6 illustrates an example of the sound pressure level as a function of frequency from two Eigen modes in a room; and

FIG. 7 illustrates an example of the combined sound pressure level as a function of frequency from Eigen modes in a room.

### DETAILED DESCRIPTION OF SOME EMBODIMENTS OF THE INVENTION

The following description focuses on embodiments of the invention applicable to a system for rendering an audio signal using e.g. a surround sound loudspeaker setup with a plurality of speakers.

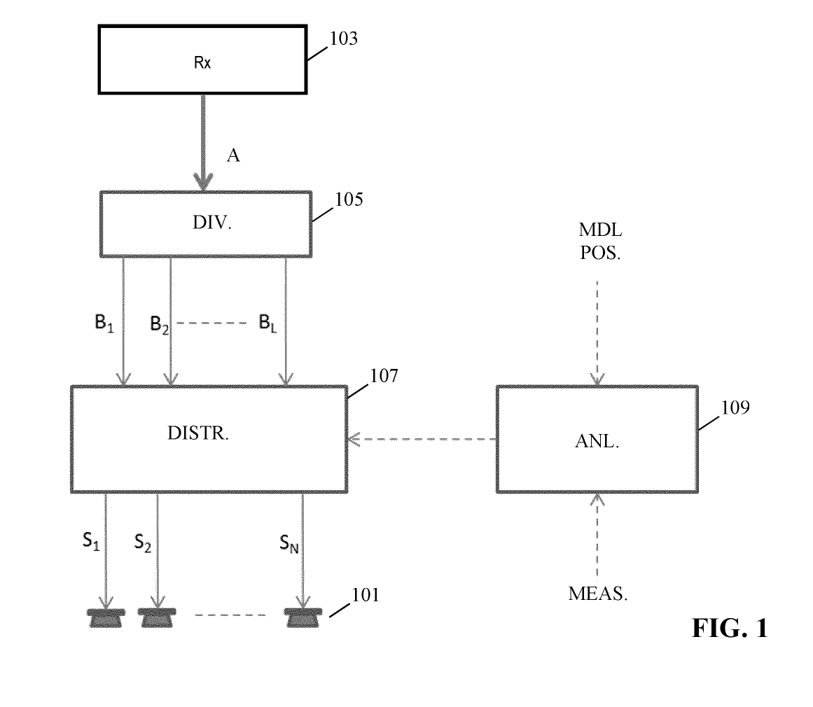

FIG. 1 illustrates an example of an audio apparatus for generating drive signals S₁-S_{N} for a plurality of speakers 101.

The drive signals S₁-S_{N} are generated from an input audio signal. The following description will for clarity and conciseness focus on the input audio signal being a single audio signal which is not associated with any specific position. However, it will be appreciated that the audio signal may for example be a component/single channel signal of a spatial multi-channel signal such as a 5.1 or 7.1 surround sound signal.

In the example, the loudspeakers 101 may for example be loudspeakers of a surround sound setup and the audio signal which is processed may be a low frequency signal, such as a Low Frequency Effect (LFE) channel. Thus, the following description may be considered to specifically be applied to such an LFE signal. However, it will be appreciated that in other embodiments, it may for example be a spatial audio signal or a single channel signal.

The audio signal A is accordingly rendered by feeding the drive signals S₁-S_{N} to the loudspeakers 101 (either directly or via intervening circuits including e.g. intervening filters, equalizers or amplifiers). The audio signal is in the specific example a low frequency signal. The rendering of a low frequency audio signal is facilitated by the fact that relatively few spatial perception cues are provided by the low frequency components. This may accordingly provide additional freedom in the rendering of the low frequency components. However, a particularly critical problem is that room responses are often not very smooth and homogenous for lower frequencies. In particular, so called room modes or room resonances may substantially affect the acoustic room response at lower frequencies. Accordingly, it is often difficult to provide a rendering of low frequencies with low distortion.

In the apparatus of FIG. 1, a receiver 103 receives the input audio signal A from any suitable internal or external source.

The receiver 103 is coupled to a divider 105 which is fed the input audio signal A. The divider 105 is arranged to divide at least part of the input audio signal A into plurality of audio subbands. The part of the input audio signal A which is divided into the subbands may in many embodiments be a frequency interval of the input audio signal A, and specifically may be a low frequency frequency interval (corresponding to bass audio). In some embodiments, the complete input audio signal A may be divided into subbands but in the described example, only low frequency parts of the input audio signal A are considered (and indeed the input audio signal A may itself be a low frequency signal, such as an LFE channel signal).

The divider 105 may accordingly generate a subband signal for each of a plurality of subbands which together cover a frequency interval, which in the example is a low frequency interval. Thus, for a first subband a first subband signal is generated, for a second subband a second subband signal is generated etc. It should be appreciated that the terms first, second, third etc. are merely labels facilitating the referencing of individual instances of terms and do not imply any absolute or relative ordering or sequence, or property or characteristic of the instances. For example, the first subband may be any of the plurality of the subbands. Similarly, the second subband may be any other subband of the plurality of subbands, and need not for example be adjacent to the first subband.

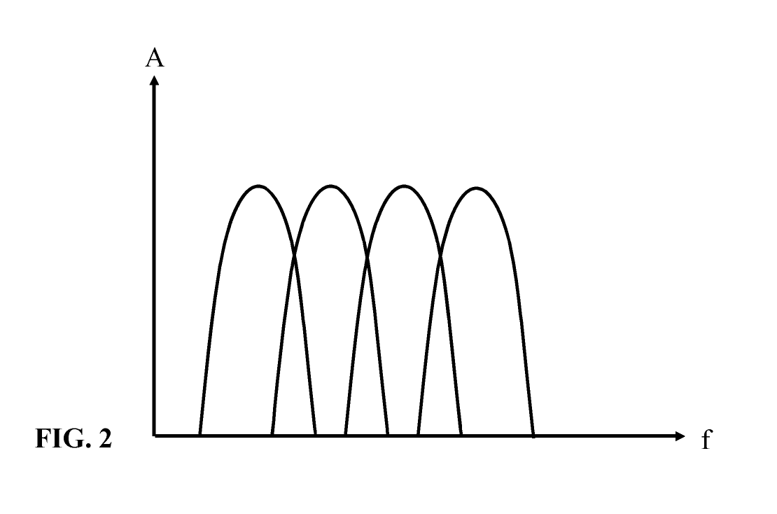

The divider 105 may for example comprise a filter bank with each filter generating a subband signal. An example, of the frequency response of such a filter bank is shown in FIG. 2. The divider 105 may implement the filter bank as a number of individual filters or may e.g. perform a Fast Fourier Transform (FFT) on (e.g. a bandwidth filtered version of) the input audio signal A.

The divider 105 is coupled to a generator or distributor 107 which is fed all the subbands signals B₁-B_{L} generated by the divider 105.

The distributor 107 is arranged to generate the drive signals S₁-S_{N} from the subband signals B₁-B_{L}. The distributor 107 may specifically dynamically and flexibly distribute each of the subband signals B₁-B_{L} to the drive signals S₁-S_{N}. The distribution may be by determining and setting a relative gain for each of the subband signals B₁-B_{L} for each of the drive signals S₁-S_{N}.

As an example, the distribution may be a selection of a set of loudspeakers 101 that are used for each sub-band, where the selection of the set may be made individually and separately for each subband, and thus with different subbands potentially using different sets of speakers. For example, a first subband may be distributed to be rendered from speaker S₁, a second subband may be distributed to be rendered from speaker S₄, a third subband may be distributed to be rendered from speaker S₂ and S₄, etc.

The distribution is based on indications of the acoustic room response for the room in which the loudspeakers 101 are positioned. Accordingly, the apparatus comprises an analyzer 109 which is arranged to generate a set of acoustic room response indications. Specifically, an acoustic room response indication is generated for each subband and loudspeaker combination. Thus, a first acoustic room response indication is generated for a first subband and a first loudspeaker, a second acoustic room response is generated for a first subband and a second loudspeaker etc.

Each of the acoustic room response indications is thus indicative of the acoustic response of the room for a given speaker and a specific subband. In many embodiments, each acoustic room response indication may be indicative of one or more properties of room resonances within the frequency subband. The acoustic room response indication may indicate the property for the room resonance(s) for a loudspeaker positioned at the speaker position associated with the drive signal for which the acoustic room response indication is provided.

The acoustic room response indication may specifically comprise an indication of whether any room resonances exist within the subband, a strength of any such room resonances, and/or a coupling of the loudspeaker to the room resonance(s). Thus, for a first subband with a first subband signal, there may be a first acoustic room response indication generated for a first loudspeaker specifically comprising an indication of whether any room resonances exist within the first subband, a strength of any such room resonances, and/or a coupling of the first loudspeaker to the room resonance(s). Furthermore, a second acoustic room response indication may be generated for a second loudspeaker specifically comprising an indication of whether any room resonances exist within the first subband, a strength of any such room resonances, and/or a coupling of the second loudspeaker to the room resonance(s). Such acoustic room response indications may be generated for all combinations of subbands and loudspeakers.

The distributor 107 may distribute each subband signal B₁-B_{L} to the drive signals S₁-S_{N} in dependence of the acoustic room response indication for the individual subband. Specifically, the distributor 107 may distribute each subband signal B₁-B_{L} dependent on whether any room resonances exist in the subband and/or the strength of any room resonances in the subband and/or the coupling of the loudspeaker to any room resonances in the subband.

Specifically, considering a first subband signal of a first subband out of the subbands, the distributor may distribute the drive signals in response to the acoustic room response indications for the first subband. The distribution to each loudspeaker depends on the acoustic room response indications, and specifically the distribution of the first subband signal to a first loudspeaker depends on a first acoustic room response indication generated for the first subband and the first loudspeaker. The distribution is performed by generating signal components for the drive signals S₁-S_{N}. For example, a relative gain for the first subband signal when generating a contribution to a first drive signal of the drive signals S₁-S_{N}, which is linked to the first loudspeaker, is determined in response to (at least) the first acoustic room response indication for the first subband and for the first loudspeaker.

As an example, the distributor 107 may for a first subband first identify whether the acoustic room response indications for the first sub-band are indicative of any room resonances existing for the room in the first subband. For example, the acoustic room response indications may be a single scalar value in the interval of [0;1] indicative of a degree to which the audio in the first sub-band excites room modes when rendered from the loudspeakers, e.g. a first acoustic room response indication may indicate the degree to which the audio in the first subband excites room modes when rendered from a first loudspeaker, a second acoustic room response indication may indicate the degree to which the audio in the first subband excites room modes when rendered from a second loudspeaker, etc. If all acoustic room response indications are within a given interval, this may be considered indicative of there not being any significant room resonances (or of them not being critically excited). In this case, the subband signal may be distributed equally across all drive signals S₁-S_{N}.

However, if the acoustic room response indications indicate that one or more room resonances do exist within the first sub-band for at least one loudspeaker, the distributor 107 may distribute the first subband signal dependent on how closely the loudspeakers are coupled to the room resonance. Specifically, if the coupling is relatively strong this may result in an exaggerated response of the room to the first subband signal whereas a weak coupling will result in a less exaggerated response. Therefore, the distributor 107 may proceed to distribute the first subband signal to only the drive signals S₁-S_{N} for which the acoustic room response indications indicates that the coupling to any existing room resonances is sufficiently low, e.g. the signal may only be distributed to a first drive signal if the coupling of the associated first loudspeaker to the room resonance(s) in the first subband is sufficiently low.

Thus, the approach may specifically distribute the subband signals B₁-B_{L} to the drive signals S₁-S_{N} such that no contributions are made to drive signals S₁-S_{N} for a speaker closely coupled to a room resonance of sufficient strength. The approach may prevent an exaggerated/amplified rendering of specific frequencies corresponding to individual low frequency room resonances. Accordingly, a more homogeneous rendering of the low frequency intervals can be achieved, and specifically the perception of a “boomy” bass due to the room characteristics and room resonances can be mitigated substantially. Similarly, the subband signals B₁-B_{L} may not be distributed to drive signals/loudspeakers that result in a substantial attenuation within the subband.

Furthermore, the approach may provide improved performance compared to compensation systems that seek to pre-compensate the rendered audio signal such that the combined effect of the pre-compensation and the excitation of the room resonances result in an acceptable overall response. Indeed, the current approach may instead of trying to compensate for the excitation of room resonances effectively seek to prevent the room resonances from being excited by the rendering of audio.

In many embodiments, the divider 105 may be arranged to generate subbands for a frequency range which is below a given frequency threshold. Similarly, the distributor 107 may distribute the subband signals to the drive signals in response to acoustic room response indications for all subbands that are below a given frequency threshold.

The frequency threshold below which the described distribution approach is applied is typically in the interval from 100 Hz to 250 Hz. Thus, in many embodiments, the frequency range of the input signal A below a frequency of between 100 Hz to 250 Hz is divided into subbands and distributed to the drive signals dependent on acoustic room response indications. This may provide a particularly advantageous operation as it may specifically provide an improved or optimal trade-off between perceived degradations in the spatial experience and perceived improvements in sound quality. Indeed, advantageously, it may allow a flexible distribution of the low frequency audio across different loudspeakers such that excitation of room resonances can be removed or reduced while at the same time reducing or minimizing the impact on the spatial perception caused by such a spatially varying rendering. Indeed, for such low frequencies, the spatial cues may be relatively insignificant thereby allowing flexibility and freedom in the positions of the loudspeakers rendering them. Furthermore, the perceptional impact of room resonances or room modes is typically much more critical for low frequencies than for high frequencies. Thus, the spatial freedom for low frequencies is used to address the quality degradation predominant for low frequencies while at the same time allowing the higher frequency signals that are less susceptible to room resonance degradation to be rendered without spatial re-distribution, thereby providing the appropriate spatial cues for the input signal.

The bandwidth (e.g. the 3 dB bandwidth) for each of the subbands exposed to the described distribution is in many embodiments no more than 70 Hz or 60 Hz, or indeed no more than 50 Hz, 40 Hz, 30 Hz or 20 Hz. In many embodiments, a bandwidth of 20 Hz±10 Hz may advantageously be used as this allows a sufficient granularity to typically isolate undesirable room resonances for individual subbands and speaker combinations while still allowing a reasonable complexity and e.g. computational resource usage.

The approach may thus be used to improve the perceived bass quality of a multi-speaker audio system by splitting the low frequency bass band (say, sub-200 Hz) of a source audio signal into several subbands, and distributing these individual subbands over the available loudspeakers in a substantially optimal way. This distribution may be achieved by for each subband establishing which of the available loudspeakers has a preferable coupling to the acoustics of the room in that frequency band, and then providing the individual subband only to the set of loudspeakers (or the loudspeaker) that have the most appropriate coupling. As will be described in more detail later, the required information about the amount of coupling of the individual loudspeakers in the individual subbands may come from direct acoustic measurements, or indirectly from a model of the low-frequency sound field in the room (based e.g. on the known geometry of the room) in combination with known loudspeaker positions.

The invention may provide a solution to the “room mode” problems of the prior art where specific frequencies may be significantly attenuated or amplified. Contrary to most existing solutions, the approach does not just improve the perceived bass quality in a fixed listening position but leads to a significant improvement throughout the room, without compromising the quality and character of the original source signal.

The approach may be based on a combination of two main steps:

Estimation of the amount of acoustic room coupling for each combination of loudspeaker and frequency subband within the frequency range of interest.

Optimal distribution of the individual subbands over the available loudspeakers, based on the estimated amount of acoustic room coupling of each loudspeaker/subband combination while using a suitable criterion for what is considered to be an optimal amount of room coupling.

As a specific example corresponding to FIG. 1, a full bass-band audio signal (containing e.g. all signal content below 200 Hz) is first divided into L non-overlapping subbands by a filter bank comprised in the divider 105. These individual subbands are input to the distributor 107. The distributor 107 for each subband decides which of the available N loudspeakers is suitable for reproducing that subband, and accordingly assigns the subbands to the appropriate loudspeaker(s). In order to do this, the distributor 107 receives acoustic room response indications, and specifically in the form of indications of a coupling from each loudspeaker to room resonances in a given subband, or an indication of a total acoustic power in a given subband, from an analyzer 109. This analyzer 109 uses acoustical measurement data or room geometry and loudspeaker position information (or any combination of these) to determine the amount of acoustic room coupling for each combination of loudspeaker and subband. Based on this information, the distributor 107 assigns the subbands to one or more loudspeakers. It should be noted that each of the N loudspeaker signals (the drive signals S₁-S_{N})may in this approach contain any sub-set of the L subbands, so the distribution of subbands over loudspeakers is not necessarily mutually exclusive.

The reproduction of audio in a room is especially for lower frequencies dependent on the existence of Eigen-modes in the room. Eigen-modes are also often in the field referred to as room modes, standing wave modes, or modal resonances.

When sound propagates in a room, it is reflected by large obstacles such as walls. This may cause resonances to occur due to the interference between the various reflected (as well as non-reflected) wave fronts. For example, two opposing walls may reflect sound such that the sound level at any given point is given by the combination/summation of the individual waves. For some specific frequencies dependent on the distance between the walls, the waves may add constructively or destructively resulting in standing waves occurring. The standing waves may occur at different harmonics (multiples) of a fundamental resonance frequency. Further resonances may occur between other opposing walls (e.g. the other two walls or between loft and ceiling). In addition, more complex reflections, such as off three or four walls may occur. Thus, the physical and geometric characteristics of a room may give rise to various room modes where interference between various waves (including reflected waves) may result in an increased relative amplification or attenuation of specific frequencies corresponding to individual room- or Eigen-modes. Indeed, the relative level difference caused by existence of room modes may especially at lower frequencies be in the order of 20 dB or even more.

Thus, when a loudspeaker renders audio, the frequency spectrum of the perceived audio may differ substantially from the frequency spectrum of the rendered signal thereby introducing distortion. The amount of distortion depends on the characteristics of the room resonances and specifically the Eigen-modes (and thus on the geometry of the room), as well as on how closely the loudspeaker couples to the Eigen-modes. Specifically, when the sound from the loudspeaker is closely coupled to the Eigen-modes of the room, the sound rendered therefrom excites the Eigen-modes causing significant standing waves at particular frequencies, thus resulting in a relatively large distortion. However, for a loudspeaker which is not closely coupled to the Eigen-modes, the resonances are not excited to a large degree, and thus only a relatively low frequency distortion occurs. The coupling of a loudspeaker to an Eigen-mode may typically depend on the position of the loudspeaker as well as on the individual frequency. The coupling is indicative of the extent to which individual room resonances/Eigen-modes of the room are excited by the loudspeaker, and depends on the relative position of the loudspeaker in the standing wave pattern corresponding to the Eigen-mode. Such a standing wave pattern is characterized by the occurrence of nodal and anti-nodal positions, where the sound pressure level is at a minimum and maximum, respectively. Due to the reciprocity principle in acoustics, a loudspeaker that is positioned at a position of maximum amplitude (anti-node) for an Eigen-mode, will also maximally excite this Eigen-mode and the corresponding room resonance, resulting in a maximum sound pressure level. Similarly, a loudspeaker positioned at a position of minimum amplitude (node) for the Eigen-mode will not excite the Eigen-mode and corresponding room resonance at all, resulting in very low sound pressure level. Loudspeakers at other positions will result in intermediate amounts of excitation of the Eigen-mode and result in intermediate sound pressure levels.

In the system of FIG. 1, the analyzer 109 generates an acoustic room response indication for each loudspeaker and each subband which is indicative of the coupling of the individual loudspeaker to room resonances in the individual subband. Thus, the acoustic room response indication for a given loudspeaker/drive signal and subband reflects the degree to which the room resonances in the subband are excited by the loudspeaker. This acoustic room response indication may accordingly be an indication of the extent or likelihood of distortion that will be caused by room resonances in the specific subband and for the specific loudspeaker.

The distributor 107 uses the generated acoustic room response indications to then (if possible) render each subband using loudspeakers for which the acoustic room response indication indicates an acceptable (or the least unacceptable) distortion. Thus, the rendering of the low frequencies is divided into individual subbands with rendering of the individual subbands from the loudspeakers that result in the least distortion due to room resonances. Furthermore, as the low frequencies do not carry many spatial cues, an audio rendering perceived to be of higher quality yet spatially consistent is achieved.

In many embodiments, the acoustic room response indication for a given loudspeaker and subband may also be indicative of a strength of the room resonance (s) in the subband. The strength of the room resonance may reflect the degree of level variation (i.e. amplification or attenuation) that may result from the room resonance. For example, it may reflect the difference between a peak and a trough for the standing wave corresponding to the room resonance. The strength of a room resonance may be a measure of the maximum amplitude that would occur within the room at the resonance frequency corresponding to the room resonance if a white noise signal would be played from a loudspeaker at a position of maximum coupling for the room resonance (i.e. an anti-node of the standing wave pattern corresponding to the room resonance). Depending on the Eigen-frequency and Eigen-mode type corresponding to the room resonance, some room resonances are more easily excited than others. For example, a lower-frequency room resonance may be more efficiently excited by frequencies surrounding the actual resonance frequency than a higher-frequency room resonance, so that for lower-frequency room resonances more acoustical energy from a broader range of frequencies may be “sucked into” the resonance, resulting in a higher boost of the energy in the frequency band around the resonance frequency. The strength may also depend on attenuation of the waves due to losses at reflective surfaces, which may be different for different room Eigen-modes. In many embodiments, it may not be necessary to individually consider the strength of a room resonance as the most significant parameter is the excitation of the resonances, and specifically the coupling of the individual loudspeaker to the resonance.

It will be appreciated that any suitably approach for determining the acoustic room response indications may be used. Indeed, various techniques can be used to estimate the amount of acoustic coupling of individual loudspeakers of a multi-speaker system in different frequency bands. Such techniques typically fall into model-based (indirect) and measurement-based (direct) techniques. The acoustic room response indications may provide quantitative measures for the amount of acoustic room coupling, and the distributor 107 may apply a quantitative criterion for the optimal or preferable amount of room coupling. Indeed, in most embodiments it will be desirable that the acoustic room response indications for the drive signals/loudspeakers to which the subband signals are distributed indicate a coupling which falls in an interval that has both a lower bound and an upper bound. Indeed, the system may exclude speakers in a given subband for which the acoustic room response indication is indicative of a coupling which is too low or too high.

In some embodiments, the analyzer 109 is arranged to generate the acoustic room response indications in response to loudspeaker position data for the plurality of loudspeakers and an acoustic model of an acoustic environment for the loudspeakers. Specifically, it may evaluate a geometric and acoustic model of the room using loudspeaker position data for the plurality of loudspeakers. The position data may e.g. be provided manually by a user or may e.g. be estimated based on measurements (such as by estimating positions from measured time of arrivals of audio signals from the different loudspeakers at microphones that are co-located with the loudspeakers).

The acoustic model may specifically be a modal model of the low-frequency response in the room. This may be used to analytically or numerically determine the coupling of individual loudspeakers at known positions to individual room modes.

Specifically, for a rectangular room of known dimensions the spatial distribution of individual modes in the room may be described by:

$${Ψ}_{l , m , n} ( x , y , z ) = cos ( \frac{l π x}{{L}_{x}} ) cos ( \frac{m π y}{{L}_{y}} ) cos ( \frac{n π z}{{L}_{z}} ) , \qquad ( 1 )$$

in which (x,y,z) is the position in the room, l, m and n are integers known as the “mode indices” in respectively the x, y and z dimensions, and Lₓ, L_{y} and L_{z} are the length, width and height of the room.

If a pressure source (monopole loudspeaker) is placed at a position (x,y,z), then the absolute value of ψ_{l,m,n} is a measure, on a scale of 0-1, of the amount of coupling of that loudspeaker to the mode with index (l,m,n).

The mode index is related to frequency through the equation:

$${f}_{l , m , n} = {\frac{c}{2} [ {( \frac{l}{{L}_{x}} )}^{2} + {( \frac{m}{{L}_{y}} )}^{2} + {( \frac{n}{{L}_{z}} )}^{2} ]}^{1 \text{/} 2} ( Hz ) , \qquad ( 2 )$$

with c being the speed of sound.

The criterion for “optimal” or “preferable” amount of coupling may in this case be defined in terms of the value of ψ_{l,m,n}. For example, it may be defined as a preferable range, such as 0.33<ψ_{l,m,n}<0.67. Or, if the main goal is to prevent excessive amplification of specific low frequencies (“boominess”) the acceptable interval may be selected to have only an upper bound, such as e.g. ψ_{l,m,n}<0.75. The latter example of a criterion may result in a rejection of loudspeaker positions that couple very strongly to any specific mode, while the former favors loudspeaker positions that have a moderate amount of coupling.

Different Eigen-modes are not all equally likely to cause practical problems. For example, modes for which at least one of the indices l, m or n is zero (so-called axial- and tangential modes) while the non-zero indices are small (e.g. equal to 1 or 2, i.e. low-order modes), are more likely to result in excessive sound pressure levels than other modes.

This is reflected in the expression for the total sound pressure at frequency f which may be given by:

$$p ( f , {\vec{r}}_{s} , {\vec{r}}_{r} ) ∝ {\sum }_{l , m , n} \frac{{Ψ}_{l , m , n} ( {\vec{r}}_{r} ) {Ψ}_{l , m , n} ( {\vec{r}}_{s} )}{( {f}^{2} - {f}_{l , m , n}^{2} ) {K}_{l , m , n}} , \qquad ( 3 )$$

in which the vectors rₛ and rᵣ are the position vectors to, respectively, the source (loudspeaker) and receiver, the sum is a triple sum over the mode indices of the three dimensions, K is a scalar that depends on the mode type (1 for axial modes, ½ for tangential modes and ¼ for oblique modes), and in which, for simplicity, it has been assumed that there is no damping.

Eq. 3 illustrates that each mode is excited not only by its exact modal frequency but also by surrounding frequencies and that at lower frequencies the sensitivity for surrounding frequencies is higher.

Furthermore, as eq. 2 illustrates, the density of modes increases with frequency, which means that low-frequency modes tend to stand out much more than higher-frequency ones. Also, at higher frequencies there is an increasing likelihood of counter-acting modes of opposite polarities that are closely spaced in frequency.

For an improved detection of problematic frequency bands, this relative strength of the individual modes may be taken into account. This may e.g. be used to prevent that a certain mode is identified as being problematic on the basis of the sole fact that one or more loudspeakers are strongly exciting it (e.g. as indicated by eq. 1), while the relative strength of this particular mode is in reality quite low.

One possible approach is to evaluate eq. 3 as a function of frequency, with the receiver term in the numerator set to 1. This effectively corresponds to calculating a worst-case spectrum that for each frequency reflects the highest sound pressure that occurs at any point in the room with the loudspeaker at the location (x,y,z).

The determined worst-case spectrum can then be used to identify problematic subbands more reliably than based on just considering eq. 1. The same methods and criteria for determining the amount of modal coupling can be used as will be explained in the following for measured frequency responses.

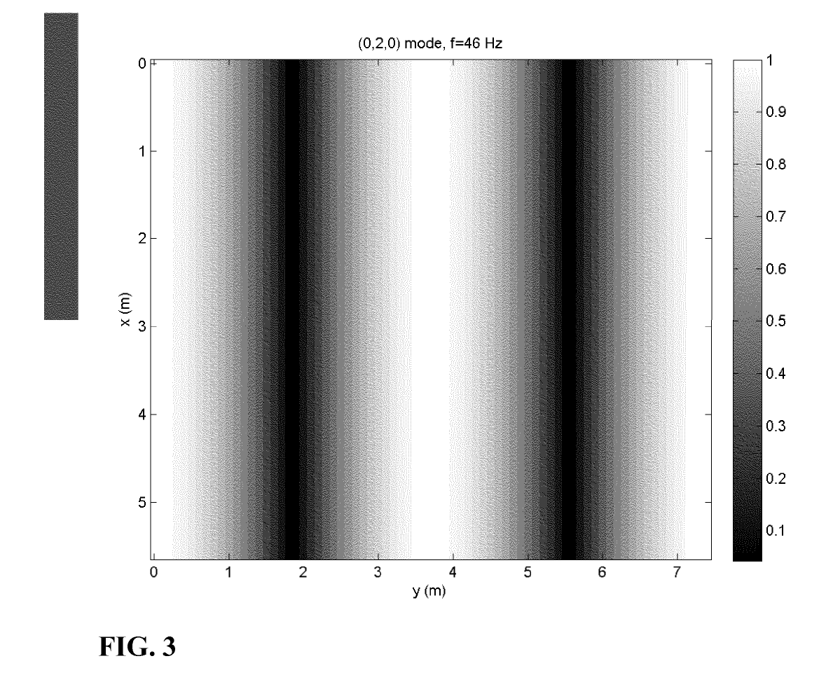

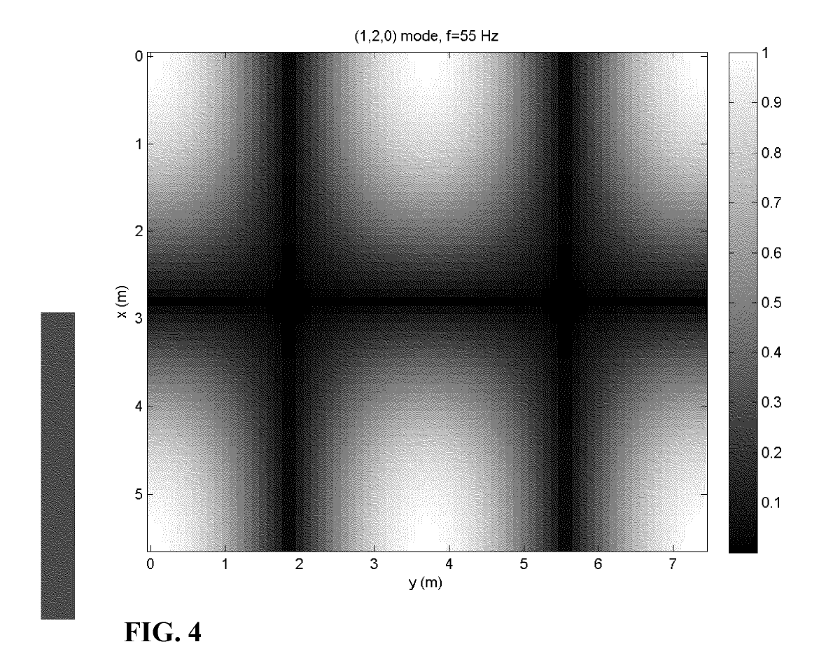

Examples of standing wave patterns in a room of size 7.4 m×5.6 m×3.0 m for two individual Eigen-modes are shown in FIGS. 3 and 4. FIG. 3 illustrates an example of an axial mode at a frequency of 46 Hz and FIG. 4 illustrates an example of a tangential mode at a frequency of 55 Hz. The graphs of the figures show the absolute value of the amplitude of equation 1 with lighter areas indicating higher sound pressure (with a small amount of dampening being included to avoid amplitudes tending towards infinity).

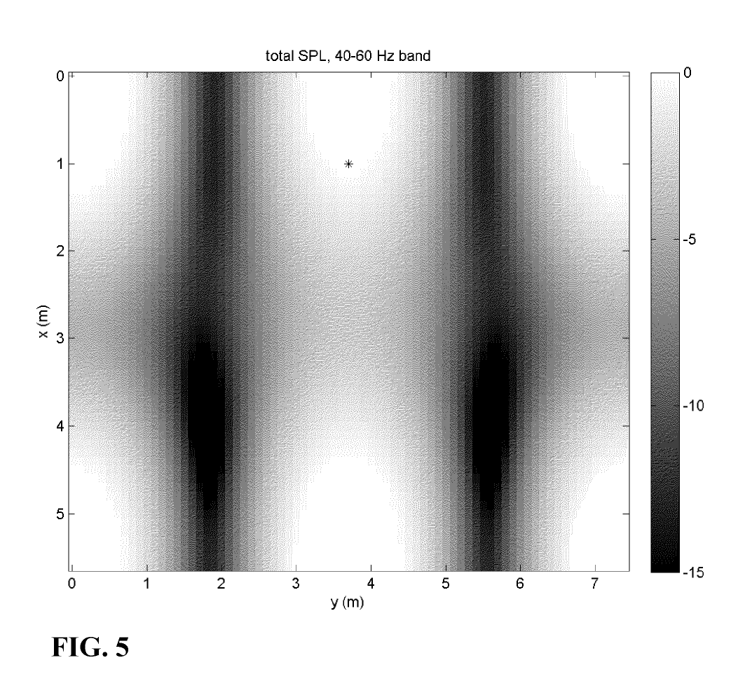

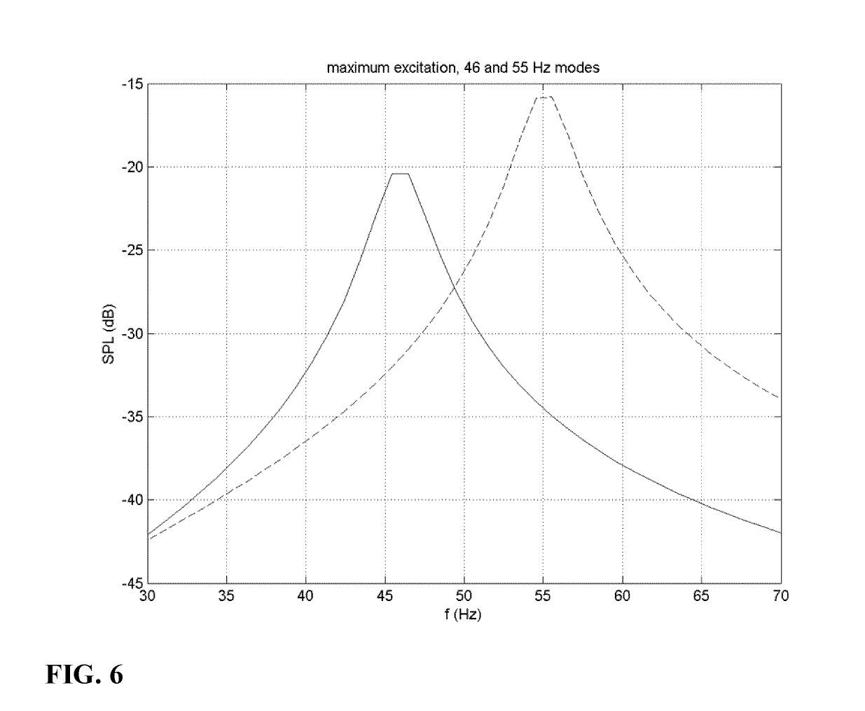

The combined effect of all modes (including the two modes from FIGS. 3 and 4) is presented in FIG. 5 for a sub-band corresponding to the frequency interval from 40 Hz to 60 Hz. FIG. 5 specifically illustrates the overall resulting sound pressure level in this subband at different positions. FIG. 6 illustrates an example of the total frequency response that would be measured at a single position.

Specifically, FIG. 5 illustrates the overall sound pressure level in the 40-60 Hz band throughout the room for a loudspeaker placed at the position of the asterisk in the graph. It clearly shows areas of high sound pressure levels (corners and mid-wall areas of the long walls) and of low sound pressure levels (the two dark vertical bands). It clearly illustrates how a very uneven rendering of lower frequencies may result for the rendering of bass audio from some loudspeakers.

Comparing the overall sound pressure levels of FIG. 5 to the sound pressure levels of the two individual standing waves of FIGS. 3 and 4 illustrates that the resulting sound pressure level is heavily influenced by the characteristics of the individual modes.

FIG. 6 shows the maximum response as function of frequency for the two individual modes (46 Hz and 55 Hz) in isolation. These were obtained by evaluating equation 3 for the two modes in isolation (i.e. only evaluating the single term of the summation corresponding to the mode) with both the source- and receiver terms in the numerator set to 1. In other words, both source and receiver are placed in a corner of the room (since the two terms are indeed 1 for a corner position, see equation 1). The result corresponds to the maximum amplitude that this mode will cause for any source- and/or receiver position in the room. Accordingly, the values at a corner position reflects a property of the mode as such, and this is independent of the specific source and receiver position. Comparing the two curves (overlayed in the same plot) provides a measure of the relative strength of one mode compared to the other. In the particular example, it can be seen that the 55 Hz mode of FIG. 4 is about 5 dB stronger than the 46 Hz mode of FIG. 3. Thus, the relative strength of the different modes may be an indication of the relative difference in the maximum amplitude level when excited by white noise (or equivalently the relative difference in the maximum amplitude level when excited by white noise may be indicative of the relative strength of the different modes).

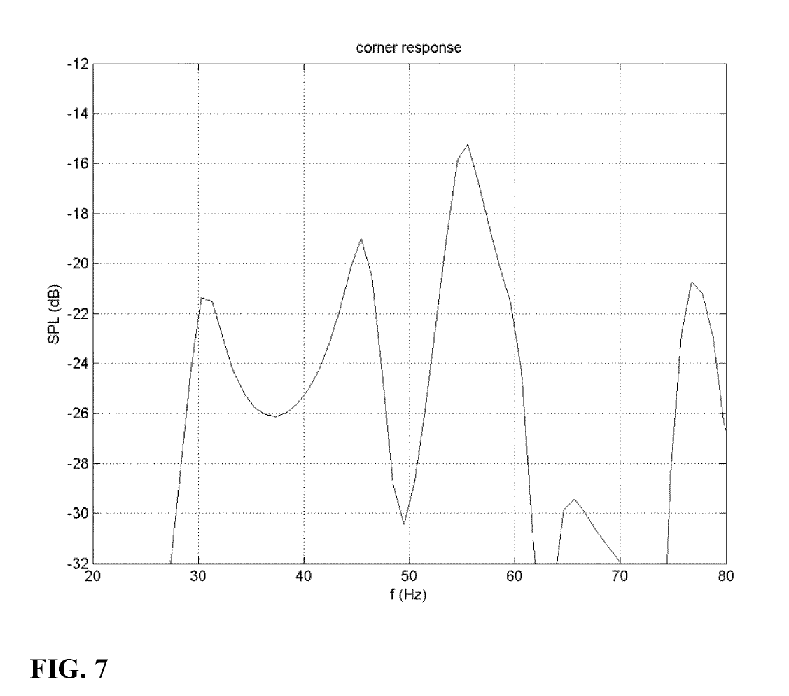

FIG. 7 shows the total frequency response that would be measured in a corner for the same situation as in FIG. 5, i.e. with the loudspeaker at the position indicated by the asterisk. The two individual resonances can clearly be seen in the total response. As will be described later, this realization that a corner position allows the resonances to be detected may be used to provide facilitated measurements to determine the acoustic room response indications. Indeed, FIG. 7 clearly illustrates that both of the two resonances can clearly be detected in the total response, and thus that a single corner measurement would allow both the 46 and 55 Hz modes to be identified as possibly causing problematic resonances.

It may be noted that when evaluating eq. 3 for source- and receiver positions in the corner (resulting in both terms in the numerator being 1), the only difference between the individual terms in the summation (i.e. the individual modes), when each term is evaluated at its respective resonance frequency, is the factor K, which only depends on the type of mode (it is either 1, 0.5 or 0.25). In some approaches, the strength of a mode may be determined as the maximum amplitude and thus it may be possible to simply have these three values for the strength. In an example of such an embodiment, the strength of a tangential mode would always be 6 dB higher than the strength of an axial mode and with the strength of an oblique mode being 6 dB stronger than the strength of the tangential mode.

In practice, it may often be more useful to look at the total amount of energy within a mode as in reality the input signal to a loudspeaker is normally not a pure sine tone and the mode is also excited by frequencies around the resonance frequency. As a consequence, it is not only the maximum value but also the width of the resonance peak that plays a role in the relevant impact of a mode. Therefore, in many embodiments the measure of strength may consider the total energy of the mode around the resonance frequency, e.g. within a 20 Hz band. Taking this approach in the specific example results in the 55 Hz mode being 4.5 dB “stronger” than the 46 Hz mode.

In some embodiments, the analyzer 109 is arranged to generate an acoustic room response indication for each loudspeaker and each subband in response to measured acoustic transfer functions from the given loudspeaker to a number of microphones, and typically to a plurality of microphones at different positions.

In such embodiments, explicit separate information about individual modes is typically not readily available but may be derived from measured transfer functions obtained at a limited number of positions in the room.

A low complexity approach for detecting problematic frequencies corresponding to room resonances is to identify peaks in the measured magnitude spectrum. For example, the measured spectrum may be compared to a smoothed (averaged) version of the same spectrum and any peaks that exceed the smoothed version by more than a given amount may be identified as room resonance frequencies. For example, peaks may be detected that are more than 12 dB above the level of the corresponding octave-smoothed response. The detection may also be performed in discrete frequency bands e.g. by summing the energy contained within each band, rather than on a quasi-continuous frequency scale.

If the measurements are made with microphones that are positioned close to, or even integrated with the individual loudspeaker, it can be considered that the measured magnitude response from each microphone is directly representative of the coupling of the corresponding loudspeaker to the room resonance (due to the reciprocity principle of acoustics, and by assuming that there are no multiple modes that are very close in frequency).

For microphones positioned at other locations in the room (or for cross-response measurements from one loudspeaker to the microphone of another loudspeaker) these assumptions are less appropriate. However, using multiple microphones at e.g. random positions will still typically allow the most problematic frequencies to manifest themselves in at least one or a few of the measured responses. Typically, measurements from three or more different positions may provide a sufficient identification of problematic room resonances and may provide substantially improved audio quality.

More sophisticated methods for detecting problematic room modes from measured responses may be used in some embodiments. Some of these may also consider the time-domain behavior of the room responses, for example by identifying frequencies that have a much longer decay time than other frequencies and which are also above a certain level. An example of such an approach is provided in Matti Karjalainen, Poju Antsalo, Aki Mäkivirta, Timo Peltonen, And Vesa Välimäki, “Estimation of modal decay parameters from noisy response measurements”, Journal of the Audio Engineering Society, Vol. 50(11), pp. 867-878, 2002.

Yet another approach for identifying the most prominent room modes is to fit a pole/zero transfer function model with common poles to the set of measured responses as e.g. presented in Yoichi Haneda, Shoji Makino, and Yutaka Kaneda, “Common acoustical pole and zero modeling of room transfer functions”, IEEE TRANSACTIONS ON SPEECH AND AUDIO PROCESSING, VOL. 2, NO. 2, pp. 320-328, 1994.

In some embodiments, the analyzer is arranged to generate the first acoustic room response indication in response to a measured acoustic transfer function from the first loudspeaker to a single microphone in a corner position. A corner position may be any position within 100 cm, or in some embodiments 50 cm of an intersection between three surfaces, such as between two walls and one of the floor or ceiling. This will for a three dimensional room correspond to the three cosine factors of eq. 1 being equal to 1 thereby allowing a single measurement position to be sufficient.

Indeed, a possible measurement method enables identification of problematic frequencies by means of a measurement with a single microphone located in one of the corners of the room.

Indeed, the inventor has realized that eq. 1 previously presented implies that all Eigen-modes will be at maximum amplitude in a corner, regardless of the position of the loudspeaker. Thus, as indicated by the combination of eqs. 1 and 3, a measurement in one corner will for each frequency reflect the highest sound pressure that occurs within the room, and accordingly will also reflect the relative strengths of the individual room resonances and the coupling of the used loudspeaker to these room resonances. Accordingly, a single measurement in the corner may be performed and used to identify problematic room resonances.

For example, a user may perform a one-off procedure in which he places a single microphone in one of the corners of the room, after which the system performs a transfer function measurement for each of the loudspeakers. This provides full information about the effective coupling of each loudspeaker to each frequency.

It will be appreciated that different approaches for distributing the subband signals to the drive signals may be used in different embodiments.

In some embodiments, the distributor 107 may be arranged to select a subset of the loudspeakers for reproducing a first subband signal in response to the acoustic room response indications for the first subband. The selection of a subset of speakers may be performed for all subbands or may only be performed for some subbands. For example, the distributor 107 may be arranged to use e.g. two predetermined speakers out of five speakers for subbands for which the acoustic room response indications meet a given criterion (such as e.g. that the coupling to any room resonances is sufficiently close to a preferred value). This may for example be convenient in systems where the two speakers have a strong frequency response for low frequencies whereas the other three speakers only have a relatively muted frequency response (e.g. due to them being physically smaller). However, for subbands wherein the acoustic room response indication is indicative of a strong coupling to a room resonance, the distributor 107 may proceed to distribute at least some of the energy of the rendered sound to loudspeakers that have a less efficient frequency response at low frequencies but which have a more preferable amount of coupling to the room resonances.

In some embodiments, the distributor 107 may be arranged to not include contributions to a drive signal for a given loudspeaker in a given subband if the acoustic room response indication for that loudspeaker and that subband does not meet a criterion. The criterion may be a criterion that requires that the speaker does not have a coupling to a room resonance which is above and/or below a given threshold. Thus, the criterion may be one which reflects a consideration of the loudspeaker not causing an unacceptable excitation of a room resonance.

For example, one strategy that may be used by the distributor 107 is to identify specific subbands in which room resonances are unacceptably excited by specific loudspeakers (either too much or too little coupling). If such problematic subband/loudspeaker combinations are identified, the distributor 107 may exclude the loudspeaker from the rendering of the audio, and thus the drive signal for that loudspeaker may not include any contribution for that subband. In such an approach, the system may only modify a nominal rendering when a problematic loudspeaker/subband combination is detected.

Another strategy that may be used by the distributor 107 is to more generally identify specific subbands which exhibit a resulting sound pressure level which is too high or too low for specific loudspeakers. A difference to the previous example may be that no information about individual room resonances or Eigen-modes is used. Rather, only observable (i.e. measurable) information about their overall combined result is used. If such problematic subband/loudspeaker combinations are identified, the distributor 107 may exclude the loudspeaker from the rendering of the audio, and thus the drive signal for that loudspeaker may not include any contribution for that subband. In such an approach, the system may only modify a nominal rendering when a problematic loudspeaker/subband combination is detected.

In some embodiments, the distributor 107 may be arranged to select a fixed number of loudspeakers for each subband signal and to include the subband signal in only the selected fixed number of loudspeakers. The fixed number may specifically be one, i.e. the distributor 107 may simply select the loudspeaker for which the acoustic room response indications indicates a coupling which is closest to the preferred or target value.

In such an approach, the system may divide the bass band into a number of subbands, and for each band determine which of the loudspeakers is considered the most optimally placed for rendering the subband signal of this subband. This approach may typically seek to optimize the overall perceived bass performance of the system, even if no explicit problems occur (although these are also avoided or mitigated in this approach).

In some embodiments, the distributor 107 is arranged to set a relative gain for each (or at least one) subband signal for each (or at least one) drive signal for a given loudspeaker of the plurality of loudspeakers in response to an acoustic room response indication for each (or the at least one) subband and for the given loudspeaker.

Specifically, the contributions for each drive signal from each subband signal in each subband may be dependent on the acoustic room response indications for the subbands and drive signals. A given subband signal may be allocated to the drive signals by a set of gains being applied to the subband signal to generate the contributions to the drive signals where the gains are a function of the acoustic room response indications for the subband for the different loudspeakers.

The approach may allow a flexible distribution of the rendering of each subband signal over the available loudspeakers. As an example, the gain for a given subband and loudspeaker may increase the closer the acoustic room response indication for the subband and loudspeaker is to a target value (e.g. the closer it is to a coupling target). The gains may e.g. be determined such that the total gain is normalized to one (or such that the total rendered sound pressure level is normalized).

Thus, in some embodiments, a gain may be applied to each subband to achieve an overall desired average frequency response.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An audio apparatus for generating drive signals for a plurality of loudspeakers, the audio apparatus comprising:
a receiver for receiving an audio signal;
a divider for dividing at least part of the audio signal into a plurality of audio subbands, the divider being arranged to provide a subband signal for each audio subband of the audio subbands;
an analyzer for generating acoustic room response indications for each loudspeaker for at least a first subband;
a generator for generating the drive signals from the subband signals wherein the generator is arranged to distribute at least a first subband signal of the first subband to the drive signals in response to the acoustic room response indications for the first subband,
said audio apparatus characterized by the analyzer being arranged to generate a first acoustic room response indication for a first loudspeaker of the plurality of loudspeakers and the first subband in response to a determination of a coupling of the first loudspeaker to at least one room resonance of an acoustic environment for the first loudspeaker.

2. The audio apparatus of claim 1 wherein the generator is arranged to select a subset of the loudspeakers for reproducing the first subband signal in response to the acoustic room response indications for the first subband.

3. The audio apparatus of claim 1 wherein the generator is arranged to not include contributions to a drive signal for a first loudspeaker if the acoustic room response indication for the first loudspeaker and the first subband does not meet a criterion.

4. The audio apparatus of claim 1 wherein the generator is arranged to select a fixed number of loudspeakers for each subband signal and to include the subband signal in only the selected fixed number of loudspeakers.

5. The audio apparatus of claim 1 wherein the generator is arranged to distribute the subband signals for all subbands below a frequency threshold to the drive signals in response to the acoustic room response indications.

6. The audio apparatus of claim 5 wherein the frequency threshold is in the interval from 100 Hz to 200 Hz.

7. The audio apparatus of claim 5 wherein a bandwidth of the subbands below the frequency threshold does not exceed 60 Hz.

8. The audio apparatus of claim 1 wherein the generator is arranged to set a relative gain for the first subband signal for a first drive signal for a first loudspeaker of the plurality of loudspeakers in response to an acoustic room response indication for the first subband and for the first loudspeaker.

9. The audio apparatus of claim 1 wherein the analyzer is arranged to generate the acoustic room response indications in response to loudspeaker position data for the plurality of loudspeakers and an acoustic model of an acoustic environment for the loudspeakers.

10. The audio apparatus of claim 1 wherein the first acoustic room response indication is further indicative of a strength of the at least one room resonance.

11. A method of generating drive signals for a plurality of loudspeakers, the method comprising:
receiving an audio signal;
dividing at least part of the audio signal into a plurality of audio subbands, the divider being arranged to provide a subband signal for each audio subband of the audio subbands;
generating acoustic room response indications for each loudspeaker for at least a first subband;
generating the drive signals from the subband signals wherein the generator is arranged to distribute at least a first subband signal of the first subband to the drive signals in response to the acoustic room response indications for the first subband, said method characterized by the generating acoustic room response indications being arranged to generate a first acoustic room response indication for a first loudspeaker of the plurality of loudspeakers and the first subband in response to a determination of a coupling of the first loudspeaker to at least one room resonance of an acoustic environment for the first loudspeaker.

12. A computer program product comprising computer program code means adapted to perform all the steps of claim 11 when said program is run on a computer.
